(19) United States
(12) Patent Application Publication
(10) Pub. No.: US 2015/0287068 A1
(43) Pub. Date: Oct. 8, 2015

(54) SYSTEM AND METHOD FOR POOLING AND CONVERTING PURCHASE REWARDS TO CASH FOR END-USERS

(71) Applicant: GROUP CASH NETWORK LLC LIMITED LIABILITY COMPANY NEW YORK, Scarsdale, NY (US)

(72) Inventors: Elliott PORCO, Scarsdale, NY (US); John LAVECCHIA, Hawthorne, NY (US)

(21) Appl. No.: 14/682,060

(22) Filed: Apr. 8, 2015

Related U.S. Application Data
(60) Provisional application No. 61/976,954, filed on Apr. 8, 2014.

(51) Int. Cl. G06Q 30/02

(52) U.S. Cl. CPC G06Q 30/0227

(57) ABSTRACT

A purchase rewards pooling and conversion system includes computing devices configured to execute modules. The modules include a user account module, a loyalty program identification module configured to receive and store information pertaining to a user's loyalty program membership, a transaction module configured to initiate purchase transactions with a retailer, a loyalty program application module configured to identify stored loyalty program membership information corresponding to a purchase transaction and transmit the stored loyalty program membership information to the retailer during the purchase transaction, a loyalty program reward conversion module configured to transmit to the retailer, with the purchase transaction, instructions to convert a portion of the loyalty program rewards earned by the purchase into a different form of rewards, a converted loyalty program rewards module configured to receive converted loyalty program rewards from the retailer, an interactive account information module, and a disbursement module configured to apply converted loyalty program rewards to at least one of a user's banking information and a purchase transaction.

This application claims priority to U.S. Provisional Patent Application No. 61/976,954, filed Apr. 8, 2014, which is hereby incorporated by reference in its entirety.

### BACKGROUND

Retailers currently have their own independent loyalty rewards programs to incentivize customers to shop regularly at their stores. These programs typically return a percentage of purchases to members, usually as points that can be redeemed only at the retailer that issued them. Retailers may also offer promotions on certain products and/or at certain times over and above the usual percentage.

Consumers may have difficulty remembering membership information or carrying around a membership card for every loyalty program they are members of, particularly at less-frequented retailers, and may not even remember that there is a loyalty reward program at a given retailer or whether they are members. Furthermore, consumers can easily forget about points balances at certain retailers, which may expire or simply go unused for long periods of time. Such points losses may decrease costs to the retailer, but also greatly reduce the value of the program to consumers, compromising the goal of the program to reward and encourage loyalty.

Accordingly, there is a need for systems and methods to improve loyalty reward program use for consumers and reward program effectiveness for the retailer.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein. Embodiments disclosed herein provide systems and methods for pooling and converting purchase rewards from retailers to cash for end users to do with as they wish.

Embodiments of the present invention differ from existing loyalty rewards programs in many important ways. Retailers and end-users opt-in to a new group cash back network that consolidates and builds on existing rewards programs to enhance their value to the consumers and to the retailers offering them. Some differences include: 1) Rewards are delivered to an app, and/or to a debit card; Users may access and make use of their rewards from the app, and/or an associated debit card as opposed to through a rewards program website or the like; 2) Rewards from different retailers who choose to participate are all delivered to the same app. Thus, users may access rewards from multiple different retailers in one place and view all current rewards balances together, and further, rewards from multiple retailers may be pooled and used together; 3) Rewards are convertible into cash. Some portion of rewards may be pooled and received as cash and spent anywhere, not only at the retailers who gave the rewards, and may even be cashed out directly to a user's bank account or the like; 4) The consumer can develop their own personalized cash back Network by picking a retailer from the Group Cash Network therefore tailoring their needs.

In an embodiment, a consumer logs onto a rewards pooling and conversion app and applies their retail rewards card(s) to the app/debit card by using the Rewards Card ID number and thereafter the Rewards Card is summoned each time when purchasing product or services.

In addition, a physical debit card may be manufactured w/ a screen, w/ download & upload capabilities, ability to store data, have wireless communication and be compatible for synchronization w/ the app.

Retail Participants of the app from all industries, such as, and not limited to, CVS, Walmart, Target, McDonalds, BestBuy, EBAY, Staples, and Gas Companies all have their own loyalty rewards programs in order to keep their competitive edge for the benefit of the general consumer. And when the general consumer uses the app, the loyalty rewards programs for all the retail participants may not be altered, only enhanced as a value added package to the consumer; a win-win. The threshold of the participants loyalty rewards programs stays the same.

The app may work by applying a percentage (such as 50%) of each retail participant's loyalty rewards programs, which is usually between 1% to 2% of purchases, into the app Group Cash Back Network for the consumer's benefit to redeem for real cash at any time.

The app may have built in security features for the consumer and may be sold at a one-time cost or on a monthly/yearly subscription model, and/or rely on ad revenue. The APP may also list user-friendly coupons to assure optimal results for the retail participant and OEM's promotional material (Colgate, Coca Cola, etc.). Furthermore, the participating Retailer of the product and services encounters no additional cost; the participating retailer has everything to gain by solidifying their OEM partner's product and their consumers' confidence and loyalty.

Census reports show that there are 7 billion people in the world and 317 million people in America that have 2.5 people in each household, which spends $50,000 per year in consumer products and services. That equates to 127 million households in America; a total of 6.3 trillion dollars in expenditures. The app provides to the consumer close to 1% real cash back on the 6.3 trillion dollars in expenditures in America, that equates to real cash back of 63 billion dollars to the consumers in America for using the app. At 127 million households in America the bottom line per household in real cash back of $500 per year in cash for using the app. As for the world the numbers of course increase incrementally.

As a retailer network associated with the app and its consumer/user base increases, other avenues of income may be realized, such as, but not limited to, from advertisers. Retailers may also offer added bonuses and/or features to consumers who are app users. For example, a retailer could offer increased loyalty program rewards (e.g. 3% instead of 2% of purchasers) to app users to compete for their business, knowing that app users may be more cost-sensitive and therefore may be encouraged to spend by such a discount/reward. Any number of incentives or other benefits may be provided specifically to app users. For example special coupons or discounts may be provided, special priveleges as far as shipping (e.g. free shipping) and/or in-store checkout or other privileges, may be provided. The retailer may even be required to provide such perks as a condition of membership in the network associated with the app. The app may allow users to search through member retailers for desired products, therefore retailers which are not members stand to lose out on sales to users searching through the app.

The app stacks real cash back from participating retailers' loyalty rewards programs, creating an unprecedented network that may transform into an equivalent debit card with cash installed.

All of this may be done on a web-based system accessible from an end-user's mobile phone or other device.

A new purchase rewards pooling and conversion system includes one or more computing devices configured to execute modules. The modules may include a user account module configured to collect and store personal and login information relating to a user and create and maintain a user account associated with that information and the user, a loyalty program identification module configured to receive and store information pertaining to a user's loyalty program membership, a transaction module configured to initiate purchase transactions with a retailer, a loyalty program application module configured to identify stored loyalty program membership information corresponding to a purchase transaction and transmit the stored loyalty program membership information to the retailer during the purchase transaction, a loyalty program reward conversion module configured to transmit to the retailer, with the purchase transaction, instructions to convert a portion of the loyalty program rewards earned by the purchase into a different form of rewards, a converted loyalty program rewards module configured to receive converted loyalty program rewards from the retailer, an interactive account information module configured to display to the user loyalty program rewards balances and a converted loyalty rewards balance, and a disbursement module configured to apply converted loyalty program rewards to at least one of a user's banking information and a purchase transaction.

The system may also include a debit card linked to the user, having identifying information and instructions that are communicated during payment transactions to a retailer to cause the retailer to provide loyalty program rewards to the user and to convert some of the loyalty program rewards into the different form of rewards.

The system may also include a debit card linked to the user account where, when a purchase is made using the debit card at a participating retailer, the purchase prompts the loyalty program application module and the loyalty reward conversion module to transmit to the retailer at which the purchase was made.

The modules may also include a conversion user selection module configured to allow the user to select a portion of the loyalty program rewards to convert into the different form of rewards.

The converted loyalty rewards may have a nominal value that is some fraction less than one of the nominal value of the loyalty program rewards.

The modules may also include an affiliate revenue module configured to receive a percentage of the amount of a purchase transaction and to deliver some fraction of that percentage to the user as loyalty rewards and/or a different form of rewards.

The modules may also include an advertising module configured to display ads to the user during the course of the purchase transaction.

The modules may also include a coupon module configured to offer coupons relevant to the purchase transaction to the user.

The different form of rewards may be currency.

A new computer-implemented method of interactive advertising, the method being implemented in a computer network that includes one or more processors executing one or more modules, may include collecting and storing personal and login information relating to a user and creating and maintaining a user account associated with that information and the user, receiving and storing information pertaining to a user's loyalty program membership, initiating purchase transactions with a retailer, identifying stored loyalty program membership information corresponding to a purchase transaction and transmitting the stored loyalty program membership information to the retailer during the purchase transaction, transmitting to the retailer, with the purchase transaction, instructions to convert a portion of the loyalty program rewards earned by the purchase into a different form of rewards, receiving converted loyalty program rewards from the retailer, displaying to the user loyalty program rewards balances and a converted loyalty rewards balance, and applying converted loyalty program rewards to at least one of a user's banking information and a purchase transaction.

The method may also include communicating identifying information and instructions stored on a debit card linked to the user during payment transactions to a retailer to cause the retailer to provide loyalty program rewards to the user and to convert some of the loyalty program rewards into the different form of rewards.

A debit card may be linked to the user account and, when a purchase is made using the debit card at a participating retailer, the method may also include transmitting to the retailer at which the purchase was made.

The method may also include allowing the user to select a portion of the loyalty program rewards to convert into the different form of rewards.

The converted loyalty rewards may have a nominal value that is some fraction less than one of the nominal value of the loyalty program rewards.

The method may also include receiving a percentage of the amount of a purchase transaction and delivering some fraction of that percentage to the user as loyalty rewards and/or a different form of rewards.

The method may also include displaying ads to the user during the course of the purchase transaction.

The method may also include offering coupons relevant to the purchase transaction to the user.

The different form of rewards may be currency.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 illustrates a system configured to pool and convert loyalty program rewards, according to an exemplary embodiment of the present invention;

FIG. 2 illustrates a method for pooling and converting loyalty program rewards, according to an exemplary embodiment of the present invention; and

FIG. 3 is a screenshot of a loyalty program rewards pooling and conversion app retailer search screen, according to an exemplary embodiment of the present invention.

FIG. 4 is a screenshot of a loyalty program rewards pooling and conversion website home page, according to an exemplary embodiment of the present invention.

FIG. 5 is a screenshot of a loyalty program rewards pooling and conversion website my stores page, according to an exemplary embodiment of the present invention.

FIG. 6 is a screenshot of a loyalty program rewards pooling and conversion website add a store page, according to an exemplary embodiment of the present invention.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, Python, Ruby on Rails, assembly language or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

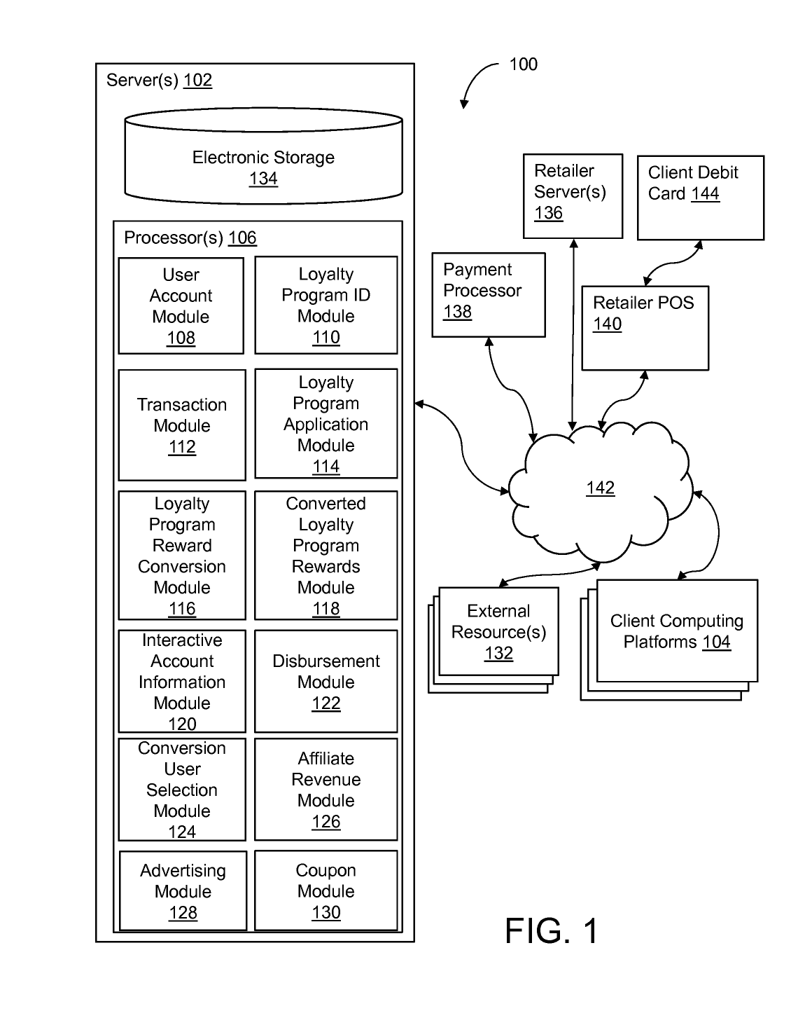

FIG. 1 illustrates a system 100 configured to pool and convert purchase rewards to cash for end-users, according to an exemplary embodiment of the present invention. In some embodiments, system 100 may include one or more loyalty rewards pooling and conversion servers 102. The server(s) 102 may be configured to communicate with a client computing platform 104 according to a client/server architecture. The users may access system 100 via client computing platform 104, for instance, to make a purchase from a retailer.

System 100 may communicate over network 142 with client computing platform 104, such as a smart phone, and with retailer server 136 to initiate purchase transactions and related communications. Retailer server 136 may communicate through network 142 with payment processor 138 to complete purchase transactions. Client debit card 144 may be used at brick and mortar retailer locations to pay for purchases using retailer POS systems. The retailer POS system 140 communicates over the network 142 with payment processor 138 to complete the transaction, and/or with retailer server 136. Completed debit card transactions may be received by the server 102 after the fact via the payment processor and/or retailer and used to determine the appropriate rewards, etc. In other embodiments, the debit card may directly communicate with the client computing platform 104 using e.g. a built-in transmitter chip, or via an attached card swiping device, and from there though the client-side app to server 102. In other embodiments, a debit card may that can connect to a Wifi network and communicate directly of the Internet may be used.

The server(s) 102 may be configured to execute one or more computer program modules. The computer program modules may include one or more of a user account module 108, a loyalty program ID module 110, transaction module 112, loyalty program application module 114, loyalty program reward conversion module 116, converted loyalty program rewards module 118, interactive account information module 120, disbursement module 122, conversion user selection module 124, affiliate revenue module 126, advertising module 128, coupon module 130, and/or other modules. Some of the modules may alternatively in part or whole reside on the client computing platform 104, which may also include one or more further computer program modules to, for example, facilitate transaction processing.

The user module 108 may be configured to collect and store personal and login information relating to a user and create and maintain a user account associated with that information and the user.

Loyalty program ID module 110 may be configured to receive and store information pertaining to a user's loyalty program membership. This module may also be configured to determine if the input ID is valid, and if the input ID pertains to a retailer that is supported by the app (e.g. has chosen to join an associated network of retailers). While retailers may be added to the program, and the details of their loyalty programs added to the system, in an essentially manual process, in some embodiments retailers may be able to join the program in an automated or semi-automated (subject to approval) process via the app or a website, etc. In such embodiments, this or another module may also handle the incorporation of the new retailers' loyalty rewards program into the system for matching against the loyalty program IDs of new end users.

Transaction module 112 may be configured to initiate purchase transactions with a retailer. This module may also manage transactions through part or all of the transaction process, and therefore may include payment security such as encryption and/or user authentication, and handle user banking/payment information. The module may also interact with disbursement module 122 when rewards/cash back are used in a purchase transaction, in which case either transaction module 112, disbursement module 122, or both may include security features.

Loyalty program application module 114 may be configured to identify stored loyalty program membership information corresponding to a purchase transaction and transmit the stored loyalty program membership information to the retailer during the purchase transaction.

Loyalty program reward conversion module 116 may be configured to transmit to the retailer, with the purchase transaction, instructions to convert a portion of the loyalty program rewards earned by the purchase into a different form of rewards.

Converted loyalty program rewards module 118 may be configured to receive converted loyalty program rewards from the retailer.

Interactive account information module 120 may be configured to display to the user loyalty program rewards balances and a converted loyalty rewards balance.

Disbursement module 122 may be configured to apply converted loyalty program rewards to at least one of a user's banking information and a purchase transaction.

Conversion user selection module 124 may be configured to allow the user to select a portion of the loyalty program rewards to convert into the different form of rewards.

Affiliate revenue module 126 may be configured to receive a percentage of the amount of a purchase transaction and to deliver some fraction of that percentage to the user as loyalty rewards and/or a different form of rewards.

Advertising module 128 may be configured to display ads to the user during the course of the purchase transaction.

Coupon module 130 may be configured to offer coupons relevant to the purchase transaction to the user.

A given client computing platform 104 may include one or more processors configured to execute computer program modules. The computer program modules may be configured to enable an expert or user associated with the given payer computing platform 104 to interface with system 100, recipient computing platform 116, and/or transaction authorization network server(s) 124, and/or provide other functionality attributed herein to payer computing platform 104.

The server(s) 102 may include electronic storage 134, one or more processor(s) 106, and/or other components and may be a high availability and/or disaster recovery-enabled system. The server(s) 102 may include communication lines or ports to enable the exchange of information with a network 142 and/or other computing platforms. The illustration of server(s) 102 in FIG. 1 is not intended to be limiting. The server(s) 102 may include a plurality of hardware, software, and/or firmware components operating together to provide the functionality attributed herein to server(s) 102. For example, server(s) 102 may be implemented by a cloud of computing platforms operating together as server(s) 102. The above comments apply equally to transaction retailer server(s) 136.

Electronic storage 134 may comprise non-transitory storage media that electronically stores information. The electronic storage media of electronic storage 134 may include one or both of a system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 134 may include one or more virtual storage resources (e.g., cloud storage, a virtual private network, and/or other virtual storage resources). Electronic storage 134 may store software algorithms, information determined by processor(s) 106, information received from server(s) 102, information received from client computing platform 104 and/or retailer server 136, and/or other information that enables server(s) 102 to function as described herein.

Client debit card 144 may be used to complete transactions at brick and mortar retail stores while taking advantage of the loyalty rewards pooling and conversion features of the app/system. Client debit card 144 is linked to the user. In some implementations, debit card 144 stores identifying information and loyalty program rewards conversion instructions that are communicated during payment transactions through the retailer POS system 140 to the retailer server 136, to cause the retailer to provide a loyalty program reward. In some implementations, when a purchase is made using the debit card 144 at a participating retailer, that purchase is reported to the linked user account on server 102. Just as for a web transaction, the modules then identify the purchase as relating to a retailer that participates, prompting the loyalty program application module and the loyalty reward conversion module to transmit the appropriate information to the retailer at which the purchase was made to provide the earned loyalty program reward to the user and convert a portion of them to the different form. This transmission may occur with substantial delay, for example one or two days, as the completion of the purchase may take a similar period of time to be reported to the server 102.

Thus, in some embodiments debit card 144 may serve as a cross-vendor, all-in-one loyalty card, and can be used to track consumer trends and improve demographic information across retailers. Thus the debit card 144, in addition to being a vehicle for financial transactions at the point of sale, also may serve as a universal loyalty card, and may have an associated app/system user account number, also serves as a universal customer ID across all linked vendor loyalty programs. These user account numbers may be stored relationally in electronic storage 134 to facilitate translation to the individual vendor customer ID for each participating vendor. Transactions qualifying for loyalty rewards may then be transmitted directly to appropriate vendors.

The user account number/universal customer ID may be translated to individual vendor IDs by a pre-determined formula to work with existing vendor customer ID formats. For example, if the given vendor customer ID has less digits, the last few digits of the user account number may be deleted to create the vendor-specific customer ID, and if the given vendor customer ID has more digits, zeros or another number may be added to the end of the user account number to create the vendor-specific customer ID.

Processor(s) 106 is configured to provide information processing capabilities in system server(s) 102. As such, processor(s) 106 may include one or more of a digital processor, an analog processor, a digital circuit designed to process information, an analog circuit designed to process information, a state machine, and/or other mechanisms for electronically processing information. Although processor(s) 106 is shown in FIG. 1 as a single entity, this is for illustrative purposes only. In some implementations, processor(s) 106 may include a plurality of processing units. These processing units may be physically located within the same device, or processor(s) 106 may represent processing functionality of a plurality of devices operating in coordination. The processor(s) 106 may be configured to execute modules 108, 110, 112, 114, 116, 118, 120, 122, 124, 126, 128 and 130 and/or other modules. The processor(s) 106 may be configured to execute modules 108, 110, 112, 114, 116, 118, 120, 122, 124, 126, 128 and 130, and/or other modules by software; hardware; firmware; some combination of software, hardware, and/or firmware; and/or other mechanisms for configuring processing capabilities on processor(s) 106. As noted, in certain implementations, a given client computing platform 104 may include one or more computer program modules. The given client computing platform 104 may include one or more processors that are the same or similar to processor(s) 106 of the server(s) 102 to execute such computer program modules of the given payer computing platform 104. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128 and 130 are illustrated in FIG. 1 as being co-located within a single processing unit, in implementations in which processor(s) 120 includes multiple processing units, one or more of modules 108, 110, 112, 114, 116, 118, 120, 122, 124, 126, 128 and 130 may be located remotely from the other modules. The description of the functionality provided by the different modules 108, 110, 112, 114, 116, 118, 120, 122, 124, 126, 128 and 130 described below is for illustrative purposes, and is not intended to be limiting, as any of modules 108, 110, 112, 114, 116, 118, 120, 122, 124, 126, 128 and 130 may provide more or less functionality than is described. For example, one or more of modules 108, 110, 112, 114, 116, 118, 120, 122, 124, 126, 128 and 130 may be eliminated, and some or all of its functionality may be provided by other ones of modules 108, 110, 112, 114, 116, 118, 120, 122, 124, 126, 128 and 130. As another example, processor(s) 106 may be configured to execute one or more additional modules that may perform some or all of the functionality attributed below to one of modules 108, 110, 112, 114, 116, 118, 120, 122, 124, 126, 128 and 130.

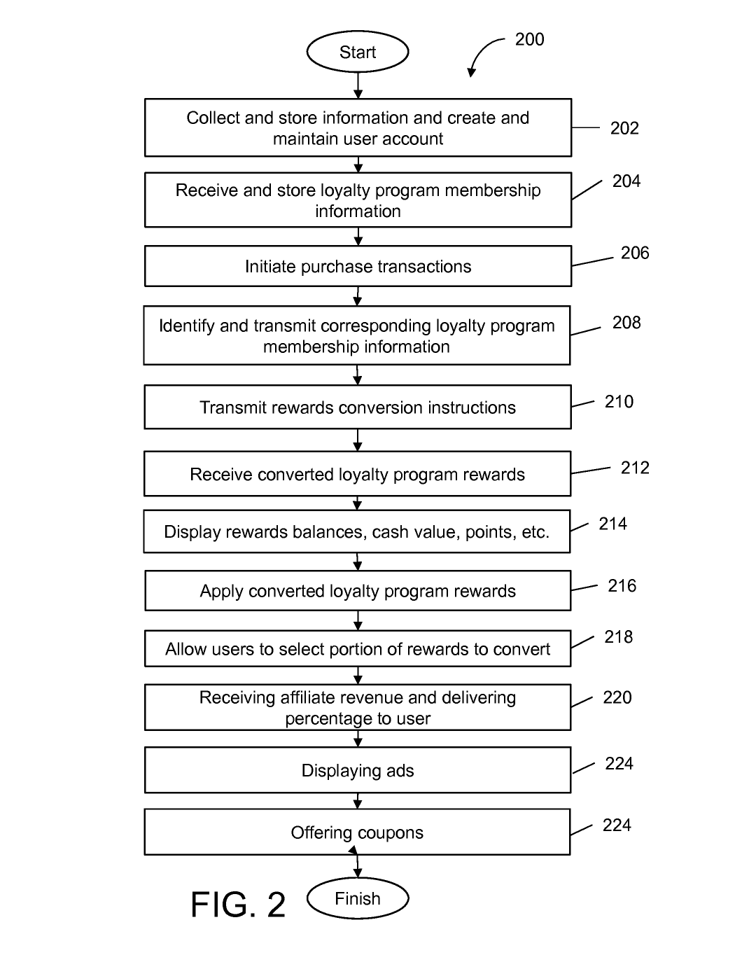

FIG. 2 illustrates an embodiment of a method 200 for pooling and converting loyalty program rewards. One skilled in the art will appreciate that the following method is presented as an exemplary non-limiting embodiment, where in other embodiments steps may be performed in various orders, combined, omitted, and/or additional steps may be included.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 202, information is collected and stored and a user account is created and maintained. This operation may be carried out by a user account module that is the same as or similar to user account module 108.

At operation 204, loyalty program membership information is received and stored. This operation may be carried out by a loyalty program ID module that is the same as or similar to loyalty program ID module 110.

At operation 206, purchase transactions are initiated. This operation may be carried out by a transaction module that is the same as or similar to transaction module 112. Transactions may be carried out through the app to ensure that the user's preferences are applied to the transaction and the user receives the rewards entitled to the user for the purchase. The retailer may be able to identify the app as the source of the purchase and have an indication as to the value created by the app in terms of increased business and sales. In some embodiments, a user may indicate their membership in a network associated with the app, and thereafter all purchases may have the user's preferences applied and the rewards pooled and converted as described, whether made through the app or not.

At operation 208, loyalty program membership information corresponding to a purchase transaction is identified and transmitted. This operation may be carried out by a loyalty program application module that is the same as or similar to loyalty program application module 114.

At operation 210, rewards conversion instructions are transmitted. This operation may be carried out by a loyalty program reward conversion module that is the same as or similar to loyalty program reward conversion module 116.

At operation 212, converted loyalty program rewards are received. This operation may be carried out by a converted loyalty program rewards module that is the same as or similar to converted loyalty program rewards module 118.

At operation 214, rewards balances are displayed. This operation may be carried out by a interactive account information module that is the same as or similar to interactive account information module 120.

At operation 216, converted loyalty program rewards are applied. This operation may be carried out by a disbursement module that is the same as or similar to disbursement module 122.

At operation 218, users are allowed to select a portion of loyalty program rewards to convert to a different form. This operation may be carried out by a conversion user selection module that is the same as or similar to conversion user selection module 124.

At operation 220, affiliate revenue is received and a percentage is delivered to the user. This operation may be carried out by an affiliate revenue module that is the same as or similar to affiliate revenue module 126.

At operation 222, advertisements are displayed to the user. This operation may be carried out by an advertising module that is the same as or similar to advertising module 128.

At operation 224, coupons are offered to the user. This operation may be carried out by a coupon module that is the same as or similar to coupon module 130.

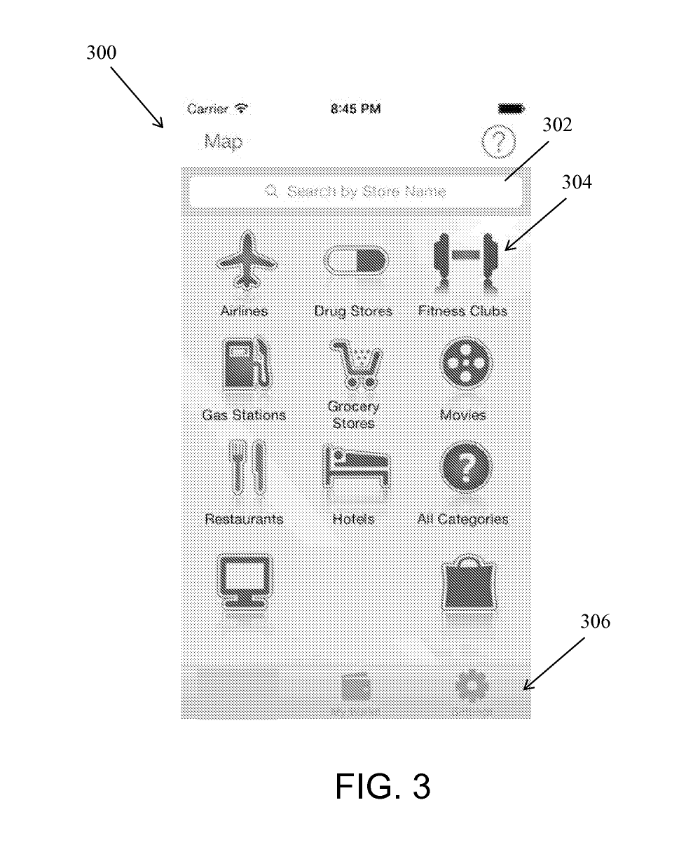

FIG. 3 is a screenshot of a loyalty program rewards pooling and conversion app retailer search screen 300, according to an exemplary embodiment of the present invention. From this screen, a user may search for retailers participating in a group cash back program, such that a portion of loyalty program rewards for the retailer may be converted into currency for the user. Here, the user can search from different categories of retailers 304, or from among all categories by searching by store name in search field 302. Global navigation options 306 at the bottom of the screen allow a user to navigate directly to settings or other pages regardless of the screen they are on.

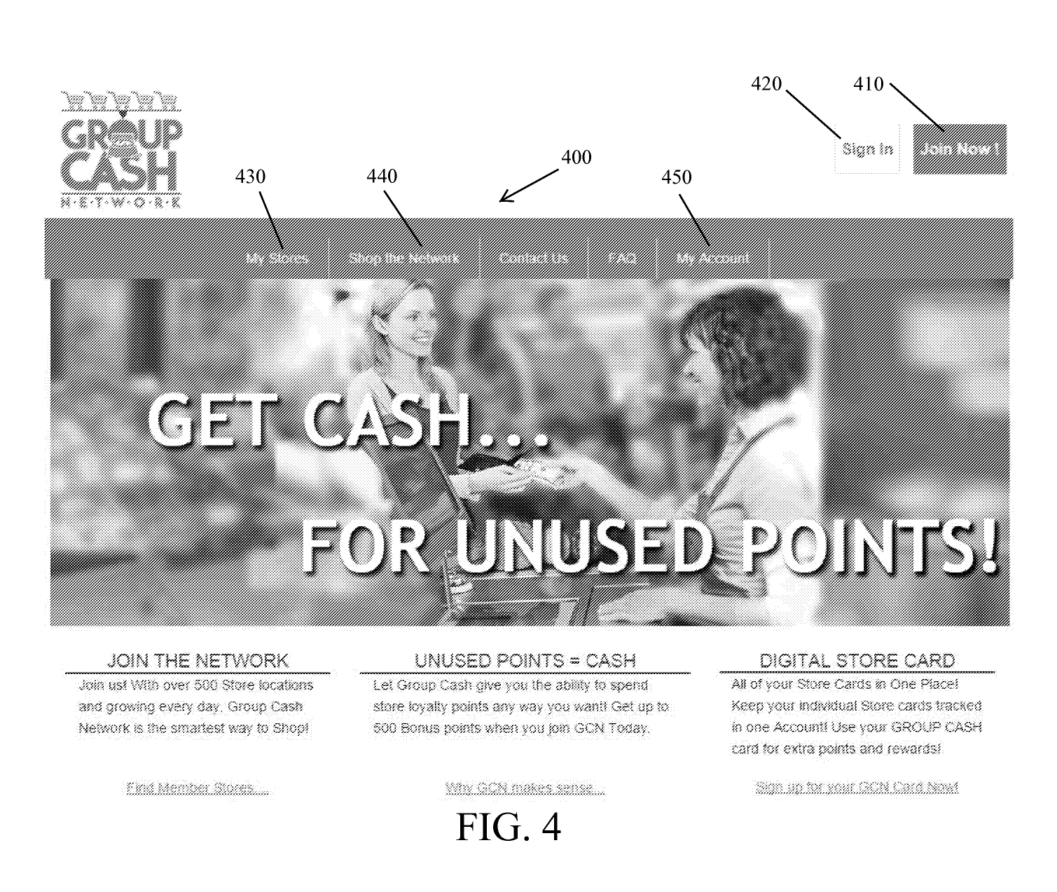

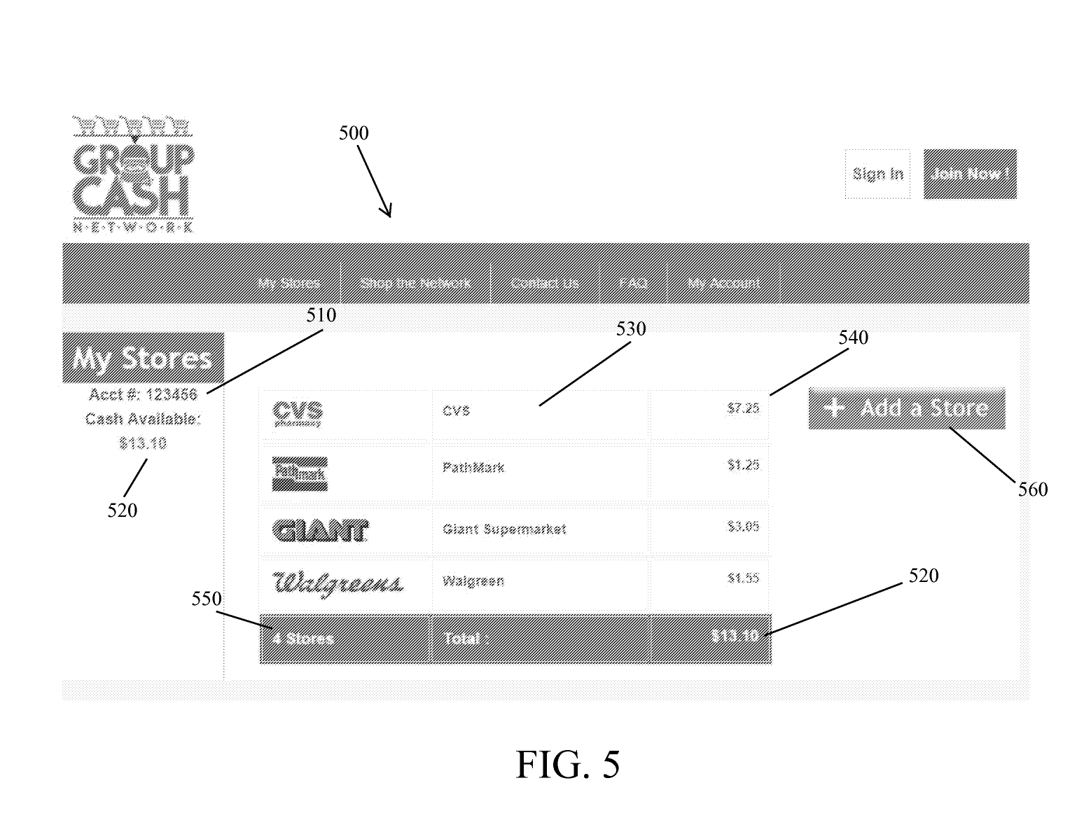

FIG. 4 is a screenshot of a loyalty program rewards pooling and conversion website home page 400, according to an exemplary embodiment of the present invention. Join now button 410 is configured to take a user to an account creation page to register for the site and create a user account and link their retailer rewards accounts. Sign In button 420 is configured to generate user ID and password fields or other authentication for logging a registered user into their account. Navigation buttons 430, 440, 450 include my stores button 430, which navigates to a page the same as or similar to that shown in FIG. 5, shop the network button 440 which provides links to online retailers who are members of the site, and my account button 450 for reviewing and changing user account information (profile information, payment information, etc.).

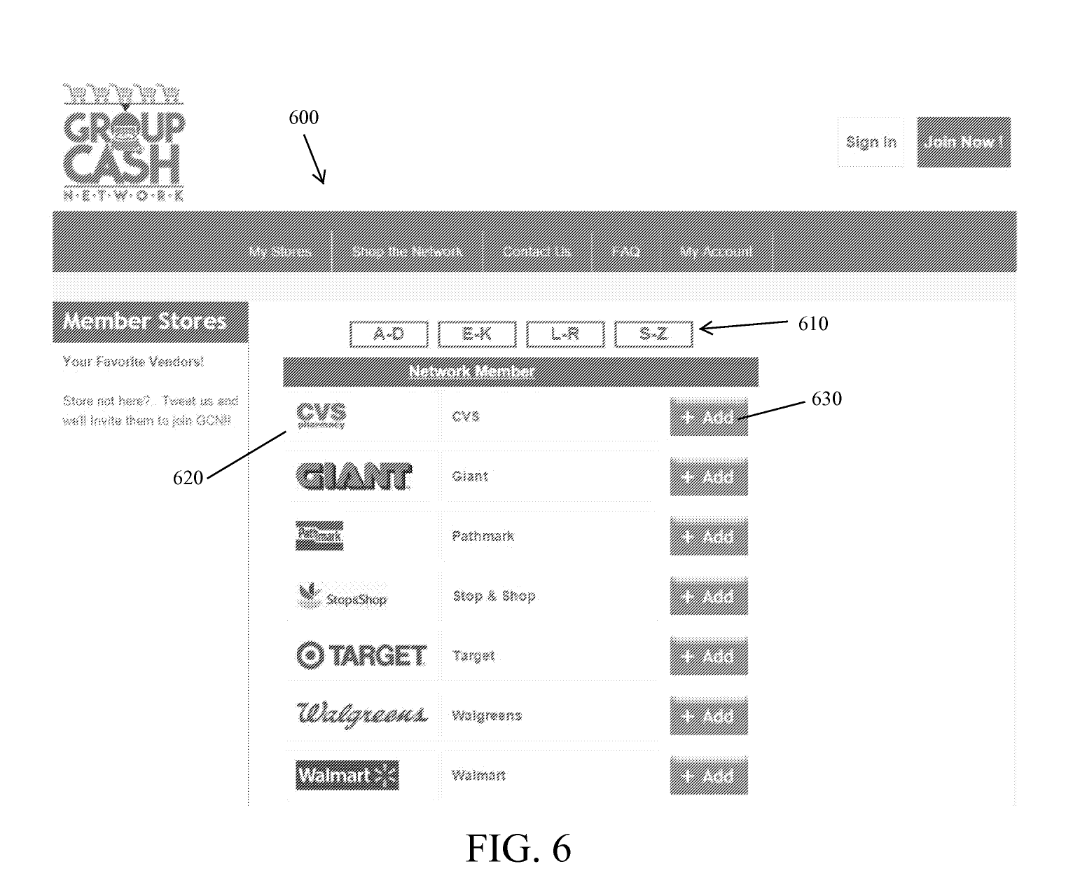

FIG. 5 is a screenshot of a loyalty program rewards pooling and conversion website my stores page 500, according to an exemplary embodiment of the present invention. On the left, the user's account number 510 is shown along with the user's total rewards cash available 520 across all linked retailer reward networks. Linked retailers 530 are listed along with their individual rewards balances 540 and the total number of linked retailers 550. Add a store button 560 is configured to navigate to page 600 shown in FIG. 6.

FIG. 6 is a screenshot of a loyalty program rewards pooling and conversion website add a store page 600, according to an exemplary embodiment of the present invention. A list 620 of retailers that are members is displayed, along with add buttons 630 for each retailer, which may be configured to link the user's rewards account with the retailer to the user account (and/or to create a new rewards account with that retailer if none exists). Navigation buttons 610 allow a user to quickly browse through large numbers of listed retailers.

The application of the present invention may be a software application, written in one or more computer code(s) and disposed on computer readable media. The application may include computer code sequences adapted to perform the functions as described in the above description and accompanying drawings. The application may be a smart device application, for example, a smart phone application, and/or a web application, web plugin and/or native personal computer application.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention. The invention encompasses every possible combination of the various features of each embodiment disclosed.

Any suitable programming language can be used to implement the routines, methods or programs of embodiments of the invention described herein, including C, C++, Java, Python, Ruby on Rails, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. In implementations, the functions of certain modules may be consolidated into a smaller number of modules, or split out into a larger number of modules, as is within the ability of one of ordinary skill in the art. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A purchase rewards pooling and conversion system, comprising:
one or more computing devices configured to execute modules, the modules comprising:
a user account module configured to collect and store personal and login information relating to a user and create and maintain a user account associated with that information and the user;
a loyalty program identification module configured to receive and store information pertaining to a user's loyalty program membership;
a transaction module configured to initiate purchase transactions with a retailer;
a loyalty program application module configured to identify stored loyalty program membership information corresponding to a purchase transaction and transmit the stored loyalty program membership information to the retailer during the purchase transaction;
a loyalty program reward conversion module configured to transmit to the retailer, with the purchase transaction, instructions to convert a portion of the loyalty program rewards earned by the purchase into a different form of rewards;
a converted loyalty program rewards module configured to receive converted loyalty program rewards from the retailer;
an interactive account information module configured to display to the user loyalty program rewards balances and a converted loyalty rewards balance; and
a disbursement module configured to apply converted loyalty program rewards to at least one of a user's banking information and a purchase transaction.

2. The system of claim 1, further comprising a debit card linked to the user, wherein the debit card comprises identifying information and instructions that are communicated during payment transactions to a retailer to cause the retailer to provide loyalty program rewards to the user and to convert some of the loyalty program rewards into the different form of rewards.

3. The system of claim 1, further comprising a debit card, wherein the debit card is linked to the user account and, when a purchase is made using the debit card at a participating retailer, the purchase prompts the loyalty program application module and the loyalty reward conversion module to transmit to the retailer at which the purchase was made.

4. The system of claim 1, wherein the modules further comprise a conversion user selection module configured to allow the user to select a portion of the loyalty program rewards to convert into the different form of rewards.

5. The system of claim 1, wherein the converted loyalty rewards have a nominal value that is some fraction less than one of the nominal value of the loyalty program rewards.

6. The system of claim 1, wherein the modules further comprise an affiliate revenue module configured to receive a percentage of the amount of a purchase transaction and to deliver some fraction of that percentage to the user as loyalty rewards and/or a different form of rewards.

7. The system of claim 1, wherein the modules further comprise an advertising module configured to display ads to the user during the course of the purchase transaction.

8. The system of claim 1, wherein the modules further comprise a coupon module configured to offer coupons relevant to the purchase transaction to the user.

9. The system of claim 1, wherein the different form of rewards is currency.

10. A computer-implemented method of interactive advertising, the method being implemented in a computer network that includes one or more processors executing one or more modules, the method comprising:
collecting and storing personal and login information relating to a user and creating and maintaining a user account associated with that information and the user;
receiving and storing information pertaining to a user's loyalty program membership;
initiating purchase transactions with a retailer;
identifying stored loyalty program membership information corresponding to a purchase transaction and transmitting the stored loyalty program membership information to the retailer during the purchase transaction;
transmitting to the retailer, with the purchase transaction, instructions to convert a portion of the loyalty program rewards earned by the purchase into a different form of rewards;
receiving converted loyalty program rewards from the retailer;
displaying to the user loyalty program rewards balances and a converted loyalty rewards balance; and
applying converted loyalty program rewards to at least one of a user's banking information and a purchase transaction.

11. The method of claim 10, further comprising a communicating identifying information and instructions stored on a debit card linked to the user during payment transactions to a retailer to cause the retailer to provide loyalty program rewards to the user and to convert some of the loyalty program rewards into the different form of rewards.

12. The method of claim 10, wherein a debit card is linked to the user account and, when a purchase is made using the debit card at a participating retailer, transmitting to the retailer at which the purchase was made.

13. The method of claim 10, further comprising allowing the user to select a portion of the loyalty program rewards to convert into the different form of rewards.

14. The method of claim 10, wherein the converted loyalty rewards have a nominal value that is some fraction less than one of the nominal value of the loyalty program rewards.

15. The method of claim 10, further comprising receiving a percentage of the amount of a purchase transaction and delivering some fraction of that percentage to the user as loyalty rewards and/or a different form of rewards.

16. The method of claim 10, further comprising displaying ads to the user during the course of the purchase transaction.

17. The method of claim 10, further comprising offering coupons relevant to the purchase transaction to the user.

18. The method of claim 10, wherein the different form of rewards is currency.
